(19) United States
(12) Patent Application Publication
(10) Pub. No.: US 2006/0230360 A1
(43) Pub. Date: Oct. 12, 2006

(54) Method for selecting signal sources of a display apparatus

(76) Inventors: Jenn-Shoou Young, Miao-Li County (TW); Weimin Tseng, Miao-Li County (TW)

Correspondence Address: J.C. Patents, Inc., Suite 250, 4 Venture, Irvine, CA, 92618, US

(21) Appl. No.: 11/323,145

(22) Filed: Dec. 29, 2005

(30) Foreign Application Priority Data
Apr. 8, 2005 (TW) 94111102

(51) Int. Cl. G06F 3/00; G06F 9/00; G06F 17/00; G06F 13/00; H04N 5/445

(52) U.S. Cl. 715/781; 725/37; 715/828; 715/829

(57) ABSTRACT

A method for selecting signal sources of a display apparatus is provided. The method comprises the steps, which is following as providing a plurality of windows for a menu, displaying the image content of a plurality of signal sources of the display apparatus via the windows, and selecting one of the foregoing signal sources.

### CROSS-REFERENCE TO RELATED APPLICATION

This application claims the priority benefit of Taiwan application serial no. 94111102, filed on Apr. 08, 2005. All disclosure of the Taiwan application is incorporated herein by reference.

### BACKGROUND OF THE INVENTION

1. Field of the Invention

The present invention relates to a method for selecting signal sources of a display apparatus, and particularly to a method for selecting signal sources, which employs a plurality of windows to display image contents and statuses of the signal sources.

2. Description of Related Art

Nowadays, conventional analog televisions (TVs) are being gradually replaced by digital TVs. Newly developed digital TVs are usually equipped with multiple input terminals in order to adapt for the more and more complicated and diversified functions thereof and standards of video/audio. Currently, a TV usually displays a menu 101 (shown as FIG. 1) on the on-screen display (OSD), thereby users can select one of the input terminals via the menu 101 to receive a signal for displaying an image.

As shown in FIG. 1, the TV has ten input terminals displayed on the and menu 101 and distributed from top to bottom, being respectively Analog TV, Digital TV, Component 1, Component 2, HDMI (High Definition Multimedia Interface) 1, HDMI 2, Composite, S-Video (Separate Video) 1, S-Video 2 and Computer. The users move cursor 102 up and down to select input terminal. As shown in FIG. 1, the cursor 102 is located at the position of Digital TV input terminal.

In addition to the above-described menu, a remote control of the TV provides key-presses for the users to select input terminals. The simplest way to do so is switching the input terminals one by one by pressing a single key-press. The better equipped TVs often provide a plurality of key-presses for switching among different input terminals, for example, providing a TV key-press for selecting conventional TV signal input terminal, an HDMI key-press for switching among several HDMI input terminals, and a PC key-press for selecting an input terminal for a personal computer.

However, the above-described methods have a variety of shortcomings. Instead of previewing the image contents of each terminal, the users often have to switch among many input terminals one by one to find out what they want. Also, the more input terminals, the more time the users need to find out what they want. Unfortunately, the quantity of input terminals of the TV is increasing generation by generation and such problem is more and more obvious.

### SUMMARY OF THE INVENTION

An object of the present invention is to provide a method for selecting signal sources of a display apparatus, which allows users to preview image contents and statuses of every signal source such as input terminals and program channels to quickly find the correct signal source.

Another object of the present invention is to provide a method for selecting signal sources of a display apparatus, thereby the key-presses of the remote control of the display apparatus for switching the signal sources can be reduced or even omitted and therefore the remote control can be slimmer and handier.

For achieving the foregoing objects and others, the present invention provides a method for selecting signal sources of a display apparatus, including steps, which are providing a plurality of windows for a menu, displaying image contents of a plurality of signal sources of a display apparatus via the windows, and selecting one of the signal sources. The present invention employs a plurality of windows for displaying the image contents and statues of the signal sources such as input terminals and program channels, which allow the users to preview before selecting signal sources. Furthermore, the display apparatus can be set as automatically skipping over the signal sources of certain statues such as No Signals or Shut Off in order to rapidly select suitable signal source when selecting the signal sources. Moreover, instead of switching the signal sources one by one, only moving the cursor can select signal sources, and therefore the key-presses of the remote control of the display apparatus for switching the signals sources can be reduced or even omitted. The remote control can be slimmer and handier.

The accompanying drawings are included to provide a further understanding of the invention, and are incorporated in and constitute a part of this specification. The drawings illustrate embodiments of the invention and, together with the description, serve to explain the principles of the invention.

### BRIEF DESCRIPTION OF THE DRAWINGS

FIG. 1 is a conventional menu for selecting signal sources.

FIG. 2 is a menu for selecting signal sources of a display apparatus according to an embodiment of the present invention.

FIG. 3 is a flowchart illustrating a method for selecting signal sources of a display apparatus according to an embodiment of the present invention.

### DESCRIPTION OF THE PREFERRED EMBODIMENTS

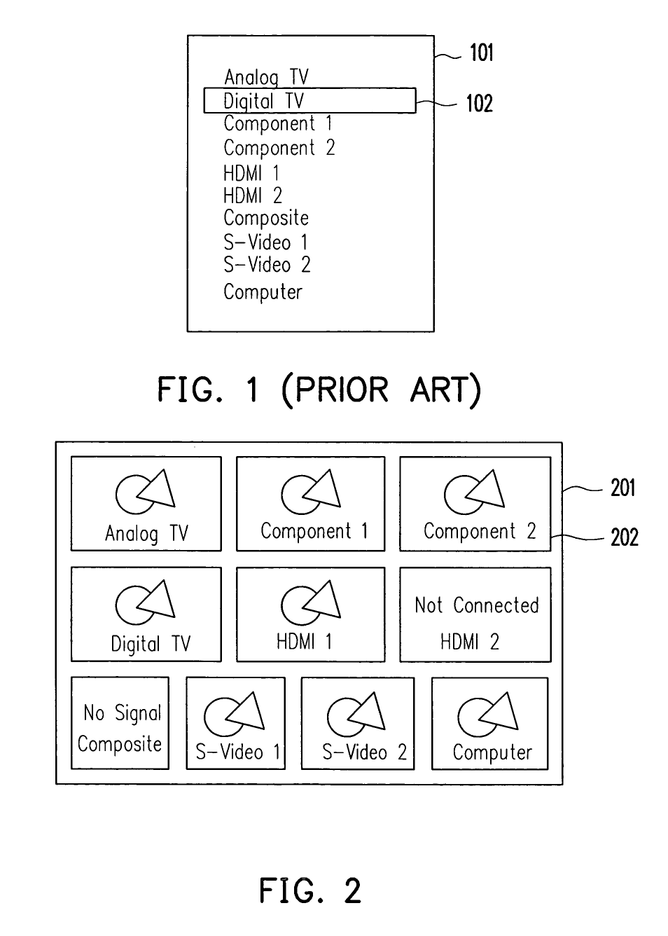

Referring to FIG. 2, a menu 201 is for selecting signal sources of a display apparatus, for example, a digital television (TV) or a projector etc., according to an embodiment of the present invention. The menu 201 is displayed on an on-screen display (OSD). Referring to FIG. 2 and FIG. 1, the menu 201 has ten input terminals the same as the menu 101 of FIG. 1. However, the menu 201 has ten windows 202 for displaying image contents of the ten signal sources. For the purpose of being easy to be identified by a user, the windows 202 of the menu 201 also display names of the signal sources at the same time. In the present invention, the signal sources can be either the input terminals of a display apparatus or a plurality of program channels received by the display apparatus such as channels provided by cable TV service suppliers. The image contents of the signal sources can be either instant extracted static images, namely snapshots, or real-time motion images. In the embodiment, the menu 201 displays all the signal sources in a single page, each window displaying the image content of only one signal source. The image content is symbolized as circles and triangles.

The menu 201 displays not only the image contents of the signal sources but also statuses thereof, for example, a second high definition multimedia interface (HDMI 2) being at a status of Not Connected and a composite being at a status of No Signal. In the embodiment, the statuses of the signal sources include Signal On (being able to play), No Signal (no signal received), Not Connected (no connection with the corresponding input terminal), Connection Failure (failure occurred in the connection between input device and input terminals), Input Device Failure and Shut Off (to be illustrated later).

The users have several ways for selecting signal sources, such as selecting with corresponding key-presses, numbering the signals sources and selecting the signals sources according to the numbers, or selecting by moving a cursor. The selecting ways can be applied on either the display apparatus or a remote control. A moving mode of the cursor for selecting signal sources is not limited. It can be a one-dimensional right-and-left moving or a two-dimensional up-and-down and right-and-left moving.

The windows 202 of the menu 201 are usually disposed in a two-dimensional matrix format. In order to speed up a movement of the cursor in the matrix and therefore speed up a process of selecting signal sources, a leftmost column and a rightmost column can be disposed next to each other, and an upmost row and a downmost row are next to each other. In other words, moving left the cursor at the leftmost window of a row leads the cursor to the rightmost window of the same row, and moving right the cursor at the rightmost window of a row leads the cursor to the leftmost window of the same row. Also, moving up the cursor at the upmost window of a column leads the cursor to the downmost window of the same column, and moving down the cursor at the downmost window of a column leads the cursor to the upmost window of the same column.

Selecting the signal sources by moving the cursor or switching in turn, the signal sources at certain statuses can be automatically skipped over for further speeding up the process of selecting. For example, the users set needless signal sources as a Shut Off status, then the certain signal sources are skipped over during selecting. More generally, the users preset a status set comprising at least one status, and the signal sources of the statuses included in the status set can be skipped over during selecting signals sources. For example, the status set consists of the statuses of No Signal and Not Connected, the signal sources of the statuses of No Signal and Not Connected can be skipped over during selecting signal sources. The above-described Shut Off of the signal sources and the status set can be set via the display apparatus or a remote control.

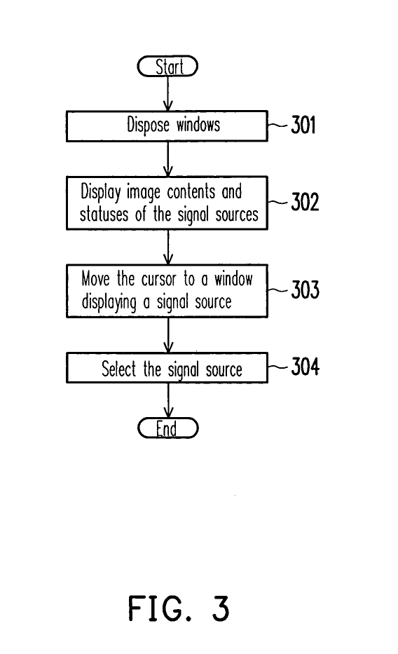

FIG. 3 is a flowchart illustrating a method for selecting signal sources of a display apparatus according to the embodiment shown in FIG. 2, the method comprising the following steps. First, at a step 301, dispose a plurality of windows to a menu. This menu having the windows is opened by pressing a key of a remote control or the display apparatus. And then at a step 302, the image contents and the statuses of the signal sources display via the windows. At a step 303, the cursor moves to one of the windows. Finally, at a step 304, the signal source corresponding to the window indicated by the cursor is selected.

The present invention is not limited to the foregoing statuses of signal sources. In other embodiments, if the display apparatus has a stronger status detecting ability, more statuses of signal sources can be displayed within the menu, including a status of a head-end apparatus and a signal quality provided by cable TV service suppliers. Also, more kinds of the statuses can be set as automatic skipping.

The menu 201 displays all the signal sources in a single page, however, it is not considered as a limitation of the present invention. In another embodiment, the menu displays all the signal sources with a plurality of pages, the pages having a double-layer structure. In this embodiment, the pages of the menu include a main page and a plurality of sub-pages, and the main page and the sub-page respectively include a plurality of windows. There is a one-to-one correspondence between the windows of the main page and the sub-pages. Each window of the main page displays all the image contents of the signal sources of the corresponding sub-pages. The user selects a window of the main page leading to the corresponding sub-page. Each window of the sub-page displays only one signal source for the selecting by users.

The foregoing double-layer structure can also be extended to a multi-layer structure, in which the sub-pages have further lower layer sub-pages. However, in the lowest layer sub-pages, one window displays only one signal source for the convenient selecting by the user. The image contents of the signal sources of the sub-pages can be displayed simultaneously via a method of dividing windows. Alternatively, the image contents of the signal sources of the sub-pages can be displayed in turn via a method of dividing times. The above-mentioned methods may be employed for the upper layer windows to display image contents of a plurality of signal sources.

In view of the above, the present invention employs a plurality of windows for displaying the image contents and the statues of the signal sources, which allows the users to preview before selecting signal sources. Furthermore, the display can be set as automatically skipping over the signal sources of certain statues in order to rapidly select the wanted signal source when selecting the signal sources. Moreover, instead of switching the signal sources one by one, simply moving the cursor can select signal sources, and therefore the key-presses of the remote control of the display for switching the signal sources can be reduced or even omitted and the remote control can be slimmer and handier.

Other modifications and adaptations of the above-described preferred embodiments of the present invention may be made to meet particular requirements. This disclosure is intended to exemplify the invention without limiting its scope. All modifications that incorporate the invention disclosed in the preferred embodiment are to be construed as coming within the scope of the appended claims or the range of equivalents to which the claims are entitled.

What is claimed is:

1. A method for selecting signal sources of a display apparatus, comprising:
disposing a plurality of windows in a menu;
displaying image contents of a plurality of signal sources of said display apparatus via said windows; and
selecting one of said signal sources.

2. The method according to claim 1, wherein said signal sources comprise input terminals of said display apparatus and program channels received by said display apparatus.

3. The method according to claim 1, wherein said image contents comprise instantly extracted static images and real-time motion images.

4. The method according to claim 1, further comprising displaying statuses of said signal sources via said windows.

5. The method according to claim 4, wherein the statuses of said signal sources comprise Signal On, No Signal, Not Connected, Connection Failure, Input Device Failure and Shut Off.

6. The method according to claim 5, further comprising:
setting a signal source as Shut Off; and
automatically skipping over said signal source as Shut Off when selecting signal sources.

7. The method according to claim 5, further comprising:
automatically skipping over signal sources comprising statuses belonged to a set of statuses when selecting signal sources, said set of statuses comprising at least one of the statues comprising No Signal, Not Connected, Connection Failure, Input Device Failure and Shut Off.

8. The method according to claim 1, wherein said step of selecting one of said signal sources further comprises:
moving a cursor to one of said windows displaying signal sources; and
selecting said signal source corresponding to said window indicated by said cursor.

9. The method according to claim 8, wherein said cursor moves in directions of up, down, left and right.

10. The method according to claim 9 further comprising:
moving left said cursor at a leftmost window of a row leads said cursor to a rightmost window of said same row;
moving right said cursor at a rightmost window of a row leads said cursor to a leftmost window of said same row;
moving up said cursor at an upmost window of a column leads said cursor to a downmost window of said same column; and
moving down said cursor at a downmost window of a column leads said cursor to an upmost window of said same column.

11. The method according to claim 1, wherein said menu displays all said signal sources in a single page.

12. The method according to claim 1, wherein said menu displays all said signal sources in a plurality of pages.

13. The method according to claim 12, wherein said pages of said menu comprise a main page and a plurality of sub-pages, each of said main page and said sub-pages respectively comprising a plurality of windows, there being a one-to-one correspondence between said windows of said main page and said sub-pages, in that every window of said main page displays all said image contents of said signal sources of said corresponding sub-page, wherefrom selecting a window of said main page leads to said corresponding sub-page for selecting a signal source of said sub-page.

14. The method according to claim 1, wherein each of said windows displays said image content of one signal source.

15. The method according to claim 1, wherein each of said windows displays said image contents of a plurality of signal sources.

16. The method according to claim 1, wherein each of said windows displays said image contents of said plurality of signal sources simultaneously via a method of dividing windows.

17. The method according to claim 1, wherein each of said windows displays said image contents of said plurality of signal sources in turn via a method of dividing times.

18. The method according to claim 1, wherein said menu is on the on-screen display of said display apparatus.
